(19) United States
(12) Patent Application Publication
(10) Pub. No.: US 2004/0177525 A1
(43) Pub. Date: Sep. 16, 2004

(54) Insert template

(76) Inventor: Anthony Wong, Franklin, MA (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/387,292

(22) Filed: Mar. 12, 2003

(51) Int. Cl. G01B 3/14

(52) U.S. Cl. 33/562

(57) ABSTRACT

The invention is directed to a template for use in making inserts for media storage cases. The template includes a body portion having a boundary edge defining a shape. The template may be placed on a sheet. The template is slideable along a top surface of the sheet, such that the template may be placed at a desired position on the sheet, for example over printed information about the contents of the media to be stored in the media storage case. The user can trace along the boundary edge onto the sheet using a pen, pencil or other drawing implement and then cut-out the shape or the user can cut the sheet directly by tracing along the boundary of the template using a knife or other cutting implement. The resulting cut-out shape forms the insert that may be inserted into the media storage case. A gripping portion may be provided on the body portion of the template, to be gripped by a user to assist in manipulating the position of the template on the sheet.

### FIELD OF INVENTION

The present invention relates to templates. More particularly, the invention relates to templates for making inserts for jewel cases for compact disc and other media storage cases.

### BACKGROUND OF INVENTION

Compact discs are a well-established form of media for recording a variety of information. There is also a miniature form of a compact disc called a mini-compact disc.

In addition to audio recording, compact discs are used for storing video information (DVDs). Compact discs are also used to store large amounts of computer information. Recording devices are available with associated recordable compact discs (CD-Rs and DVD-Rs.)

Other forms of compact discs are available, including CD-I, CD-Rom and CD-Text, which differ in their recording capabilities and the various formats in which data is stored onto the discs, as is known in the art.

Other applications for compact disc use include the photo-CD, which records still images for viewing on a television or computer screen or reproduction as hard copy, and the multimedia CD, which holds pictures, sound and text information on one disc that can play the data back through television receivers and hi-fi equipment or appropriately configured computer systems. All of the various forms of CDs described above and others known in the art will be referred to herein as “compact discs”. Additionally, “media storage devices” will refer to all forms of media to store data or other information, including compact discs.

Compact discs are usually shipped and stored in thin flat containers referred to as “jewel” cases or boxes. Such cases are generally made of a durable transparent plastic such as polycarbonate or styrene.

Typically, information about the compact disc, such as its information content, is provided by inserts, in the form of booklets or sheets, carried against the cover or base of the jewel case so that the information is visible through the flat, transparent panels of a jewel case's front cover or back cover, or both. Information may also be visible through the binding, or edge, of the jewel case. As the practice of recording various data on all manner of media storage devices, including compact discs, becomes more and more commonplace, there arises an associated need for users to be able to recognize and identify the information stored on individual media storage devices.

Customarily, users may write on the label or other surface of the compact disc or other media to identify its contents or provide other information. However, the space is generally small limiting the amount of information that may be supplied. Alternatively, blank inserts may be provided with jewel cases or other media storage cases; however, this requires the user to write on the insert the desired information about the compact disc or other media. The user must clearly write the information by hand, which can be time consuming and imprecise. If a blank insert is not provided, making inserts by hand can be time consuming and repetitive, and prone to ill-fitting inserts due to the trial and error approach.

There are other methods available for providing inserts with information about compact discs. For example, specially perforated paper may be used for printing a content list or other information from a computer. The correct sized insert is then separated from the paper by breaking the perforations and inserting the resulting insert into the jewel case. However, this requires the user to print the information within the perforated boundaries of the insert as provided on the specially prepared paper. It can be difficult to align the printed information properly within the perforated boundaries of the paper, and often requires the use of special software. The perforations may not be suited for the specific jewel case insert being prepared, and the perforations may not always tear along the desired path. Multilayer sheet assemblies may also be found which provide a single sheet with perforations for making a compact disc label, an insert or other desirable sheet portions for a jewel case. However, these sheet assemblies still require proper alignment within the perforations and may require the use of special software to properly align the information.

### SUMMARY OF INVENTION

The inventor has appreciated that providing an insert for a media storage case, for example for use in providing information about the media, may be solved by providing a template that may be used to make an insert of the proper size and from any desirable sheet, such as a printed sheet of paper with or without perforations. This may allow a user to print desired information about media anywhere on any type of sheet and still make an insert that both contains the printed information and fits within the media storage case for display.

According to one embodiment, a template for guiding a writing or cutting implement on a sheet that may be carried relative to a front or back cover, or an edge, of a case adapted to hold media is disclosed. The template comprises a body portion having a boundary edge defining a shape and a gripping portion provided on the body portion. The gripping portion is constructed and arranged to be gripped by a user to manipulate the position of the template. The edge defines a shape that corresponds to the shape of an insert for a case adapted to hold media.

According to another embodiment, a method for forming an insert for case adapted to hold media is disclosed. The method comprises the steps of providing a template including a body portion having an edge defining a shape, wherein the edge defines a shape that corresponds the shape of an insert for a case adapted to hold media, positioning the template on a sheet and tracing the edge with an implement.

### BRIEF DESCRIPTION OF DRAWINGS

The objects, advantages and features of aspects of the invention will be more clearly appreciated from the following detailed description, when taken in conjunction with the accompanying drawings, wherein like numbers are used for like features, in which:

FIG. 1 is a perspective view of a template according to one embodiment of the invention;

FIG. 2A is a front view of the template of FIG. 1;

FIG. 2B is a cross-sectional view of the template of FIG. 2A taken along line 2B-2B;

FIG. 3 is a side view of the template of FIG. 1;

FIG. 4A is a front view of another embodiment of the template according to the invention;

FIG. 4B is a detailed view of the gripping portion of the template of FIG. 4A;

FIG. 5 is a front view of another embodiment of the template according to the invention;

FIG. 6 is a exploded perspective view of a conventional compact disc jewel case shown in its open position along with a compact disc and insert;

FIG. 7A is a perspective view of another type of compact disc storage case in an open position;

FIG. 7B is a front view of another embodiment of the template according to the invention for use with a media storage case, such as one shown in FIG. 7A;

FIG. 8 is a perspective view of another embodiment of an adjustable template according to the invention;

FIG. 9 is a top view of another embodiment of an adjustable template according to the invention;

FIG. 10A is a top view of another embodiment of an adjustable template in a first position according to the invention having an adjustable shape; and

FIG. 10B is a top view of the template of FIG. 10A in a second position.

### DETAILED DESCRIPTION

The invention is directed to a template for use in making inserts for media storage cases. The inserts may contain information, such as information describing the contents of the media storage device (hereinafter media) stored within the media storage case. Although the templates illustrated in the drawings are for inserts to be used in compact disc storage cases for storing compact discs, such as jewel cases, it is to be appreciated that the template may be configured for making inserts for any type of media storage case for storing any type of media.

The template is used to make inserts that may include information about the media stored in the media storage case. The information about the media, such as files or data stored on the media, may be printed, for example from a computer, onto a sheet. The template may then be aligned in a desired position over the printed information and the insert can be either traced or cut using the template, such that a proper sized insert is made that can be slid against the front cover panel of the media storage case. Alternatively, the insert could be placed against the back cover of the media storage case. Also, it will be appreciated that the template may be sized to form an insert for a spine of the media storage case.

In order to make an insert, the template may be placed on a sheet. It is to be appreciated that the sheet may be any type of sheet such as paper, paper board, construction paper, photo paper or the like, and may include an adhesive backing. The sheet may have information about the particular media, such as the contents, printed on the sheet. For example, the information may include names of files, photos, images, artwork or other information to alert the user of the contents or the owner of the media. The template is slideable along a top surface of the sheet, such that the template may be placed at a desired position on the sheet, for example over printed information about the media. The template defines a boundary along which a user can trace a shape onto the sheet using a pen, pencil or other drawing implement and then cut-out the shape or the user can cut the sheet directly by tracing along the boundary of the template using a knife or other cutting implement. The resulting cut-out shape forms the insert that may contain information about a particular media and the insert may be inserted into the media storage case storing that particular media. Thereafter, the user only needs to look at the front cover of the media storage case to determine information about the media contained within the media storage case.

The template may have any suitable configuration to form a boundary that defines a shape that corresponds to an insert for a media storage case. For example, the template may be substantially square, rectangular or circular depending on the shape required for the insert to be placed in the media storage case. Either an outside or inside boundary of the template may be used to trace the insert. The template may also have a gripping portion on its top surface to assist the user in positioning the template on a sheet to trace or cut-out the insert. Now the particular embodiments of the invention illustrated in the drawings will be discussed.

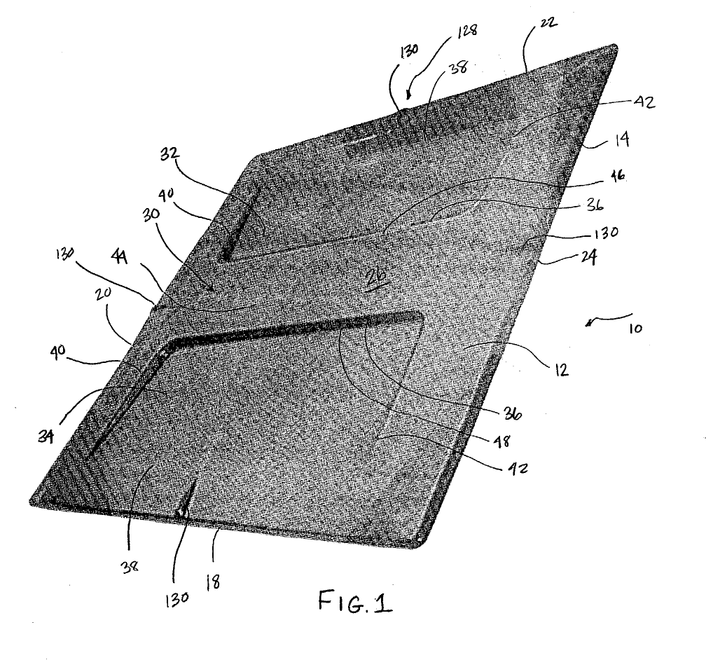

Referring to FIGS. 1-3, a template according to one embodiment of the invention is illustrated. The template 10 includes a body portion 12 having a boundary edge 14. The boundary edge defines a shape and forms an edge to trace for making an insert 16 (see FIG. 6). It will be appreciated that the boundary edge may form any suitable shape for making an insert to fit within a media storage case. As illustrated, the template has a substantially square shape with a first, second, third and fourth outer edges 18, 20, 22 and 24 that form the boundary edge 14. The edges form a traceable shape that is substantially the same shape and size as an insert for a jewel case. As shown, the edges are connected with one another to form a continuous boundary edge. However, it will be appreciated that the boundary edge may be discontinuous such that the edges are not directly connected with one another.

The body portion 12 of the template includes an upwardly facing top surface 26 and a substantially flat bottom surface 28. The bottom surface 28 may be placed against a sheet to trace the boundary edge of the body portion to make the insert. The substantially flat, smooth bottom surface enables the template to be slid on the sheet to any desired location. The user may place their hand on the top surface 26 to hold the template in a desired position while tracing the edges.

The top surface 26 of the template may have any suitable configuration. As illustrated, the top surface features a gripping portion 30 to assist the user in sliding the template to the desired position on the surface of the sheet and holding the template in the desired position while tracing or cutting-out the insert. The gripping portion may be any structure or feature provided on the body portion to assist in moving the template. The gripping portion enables the template to be moved to the desired position without lifting the template off the sheet.

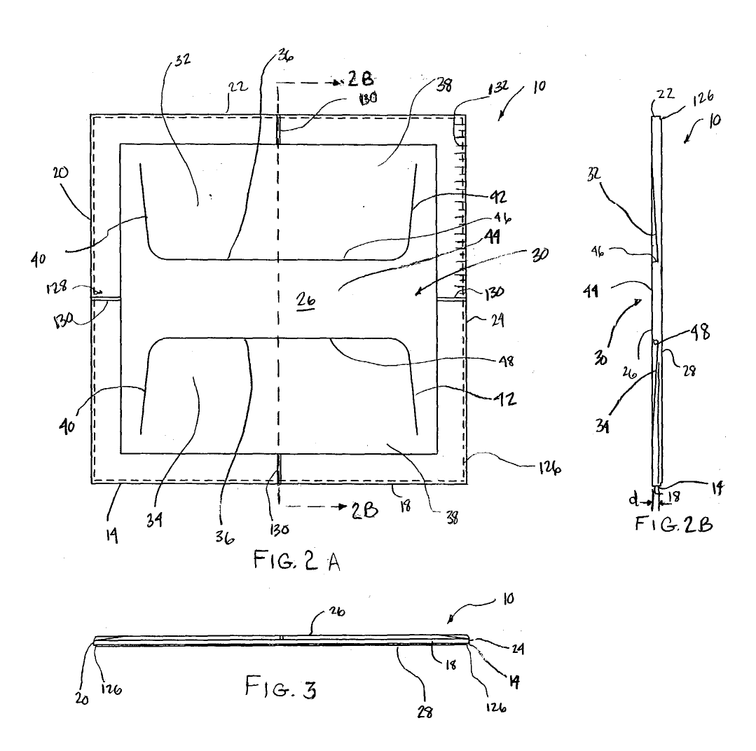

In FIG. 1, the gripping portion is illustrated as two recesses 32 and 34 formed in the top surface. The recesses are substantially rectangular with an inner edge 36 near the central portion of the template and an outer edge 38 closer to the outer edge of the template. Two side portions 40 and 42 join the inner and outer edges of each recess and flare slightly outwardly from the center portion of the template to the outer edge. As shown in FIG. 2B, the recesses increase in depth from the outer edge to the inner edge to a maximum depth d. The illustrated template features two substantially identical recesses. It is to be appreciated, however, that one or more recesses may be provided in the top surface of the body portion to form the gripping portion. Moreover, the recesses may be different shapes, sizes and/or depths. The depths of the recesses may be the same throughout or may be varied as illustrated.

The recesses 32 and 34 form a bar 44 between them. The bar 44 includes sides 46 and 48 formed by the recesses that may be gripped by a user's fingers and/or thumb when sliding the template along a surface. As shown, the bar is at an even height with the top surface; however, the bar may be higher or lower than the top surface of the body portion of the template. Moreover, it is to be appreciated that the bar may be arched or otherwise formed such that at least a portion of the bar is raised above or below the top surface of the body portion. The user may place their fingers anywhere on the top surface or bar of the template to slide the template around on the surface of the sheet.

Another embodiment of the gripping portion is illustrated in FIGS. 4A and 4B. The gripping portion 30 may be a handle 50 provided on the top surface 26 of the body portion 12 for the user to grasp when moving the template around. It is to be appreciated that the handle may have any suitable shape and may extend upwardly from the top surface of the template or may form an indentation in the top surface of the template. As illustrated, the handle has a thinner neck 52 extending from the top surface of the body portion with a knob portion 54 on the top of the neck that may fit within a palm of the user's hand.

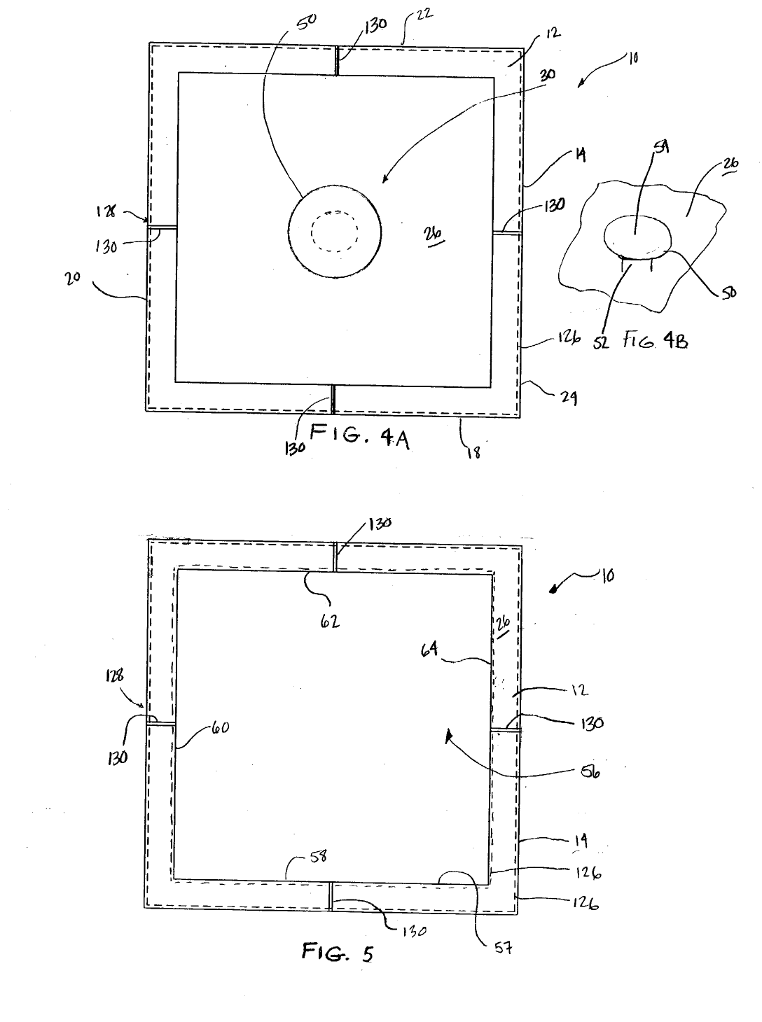

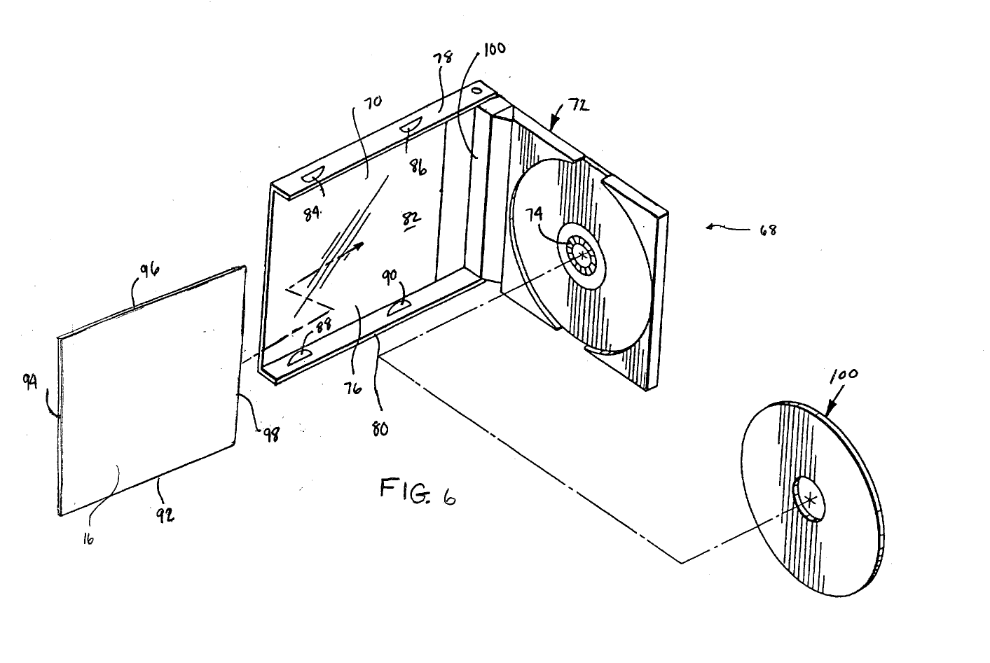

As illustrated in FIGS. 1-4B, the template 10 is solid. It is to be appreciated, however, that at least one of the recesses of FIGS. 1-3 may extend through the template to form a hole or holes in the template. Additionally, as illustrated in FIG. 5, the body portion of the template may include a hole 56 that defines a second boundary edge of a second traceable shape. For example, the second traceable shape may allow a user to make a different sized insert for a different type of media storage device. As illustrated, the template 10 features the boundary edge 57 as first, second, third and fourth inner edges 58, 60, 62 and 64 that define a shape for tracing or cutting to form an insert for a media storage case, such as a jewel case. It will be appreciated that either one or both of the inner or outer traceable boundary edges 14 and 57 may be provided on the template and either may be sized and shaped to form an insert for a jewel case. It will be appreciated that the template of FIG. 5 may also feature a gripping portion. The gripping portion may be provided on the remaining body portion of the template or may extend across the hole 56 that forms the inner edges in any suitable manner.

A conventional jewel case 68 in which to place the insert is illustrated in FIG. 6. Each case 68 includes a front cover 70, a back cover 72, and a compact disc carrier or holder 74. The front cover 70, back cover 72 and disc holder 74 are typically injection molded of a suitable plastic. Each case typically measures about 142 mm by about 124 mm by about 10.4 mm in a closed state. For convenience, the front cover 70 and back cover 72 are transparent and molded of styrene or polycarbonate, while disc holder 74 may be made of either transparent or opaque plastic, colored as desired.

The front cover 70 comprises a front flat panel 76 which has upper and lower raised edges 78 and 80, respectively, extending from a rear surface 82. Upper raised edge 78 has a pair of spaced apart tabs 84 and 86 extending outwardly therefrom while lower raised edge 80 is provided with a similar pair of tabs 88 and 90. Tabs 84, 86, 88 and 90 are configured and arranged to have corresponding edges 92, 94, 96 and 98 of an insert 16, which may be made as described above, slide underneath them to retain it with its front surface against the rear surface 82 of transparent front cover panel 76. In this manner, information carried on the front surface of the insert 16 can be clearly seen through the front flat panel 76 of the front cover 70. The insert sized to fit against the cover panel of a jewel case is substantially square and typically measures about 119.5 mm by about 120.5 mm. However, it will be appreciated that different sized inserts in a range of sizes and shapes will fit within jewel and other storage cases.

Back cover 72 also may have a transparent flat panel (not shown). The front cover 70 and back cover 72 are hingedly or pivotally connected to one another in any suitable manner for movement between open and closed positions. A compact disc 100 may be inserted into the case onto the compact disc carrier 74 and the front cover and back cover may be pivoted toward one another to close the case securing the compact disc inside.

A second insert, possibly with additional information about the compact disc, may be provided in the back cover with its information against the transparent flat panel so that it can be seen and read by a user. Additionally, the spine 100 of the case 68 may contain information about the contents of the compact disc too, such that a third insert may be placed in the spine with the information facing outward. It will be appreciated that any of the inserts may be used either alone or in combination with one another.

Although a particular jewel case has been illustrated and described, the jewel case may take on numerous different configurations. For example, the back cover and disc holder may be formed unitarily. In this case, no insert may be provided in the back cover; however, the jewel case may have a thinner profile. Numerous different shaped media storage cases exist for shipping and storing compact discs. For example, the case may be substantially round on at least a portion of the case, such that the insert may be at least partially rounded. Moreover, the media storage case may be a sleeve into which a compact disc is to slid for storage. The sleeve may be flexible and made of plastic. An insert may be inserted into the sleeve with the compact disc, for example, to describe certain information about the compact disc. Thus, as used herein, media storage case is intended to cover all such cases and other media storage cases that may be used to ship and/or store compact discs and other media.

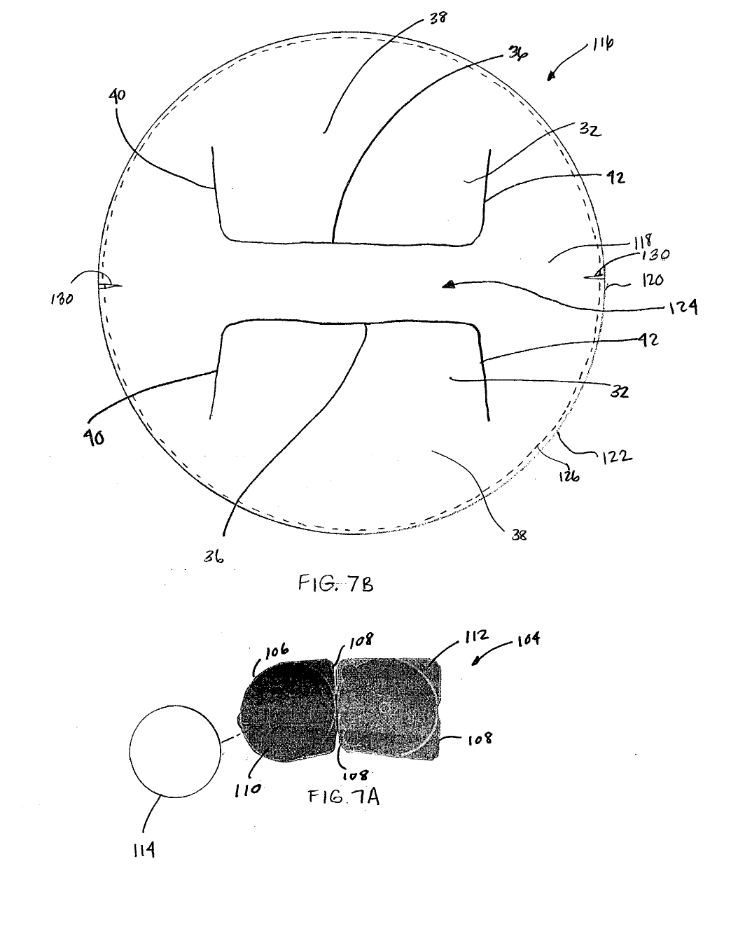

Referring now to FIGS. 7A and 7B, a different embodiment of the template is shown with another type of media storage case. The media storage case 104 of FIG. 7A features a rounded side 106 and a square side 108 of front cover 110 and square sides 108 of back cover 112. A circular insert 114 to fit within the case may be formed using the template 116 shown in FIG. 7B. The template is shown having a body portion 118 and a boundary edge 120. The boundary edge includes an outer edge 122 that is substantially circular and forms a shape that is substantially the same size as an insert 114 for the media storage case of FIG. 7A. A gripping portion 124 is provided on the body portion similar to that described above with regard to FIGS. 1-3. It is to be appreciated, however, that the gripping portion may have any suitable configuration.

It is foreseeable that the template may be created such that its size or shape is adjustable. For example, in a first position the template may be sized to form an insert for a compact disc storage case or other media storage case, while in a second position the template may be sized to form an insert for a mini-compact disc storage case or other media storage case. Alternatively, in a first position the template may be substantially circular while in a second position the template may be substantially square or rectangular. In order to adjust the size or shape of the insert between first and second positions, sliding members and hinges may be provided on the template. Specific exemplary adjustable template embodiments will now be discussed. However, it will be appreciated that these are not intended to be limiting as numerous different configurations will be apparent to one of skill in the art.

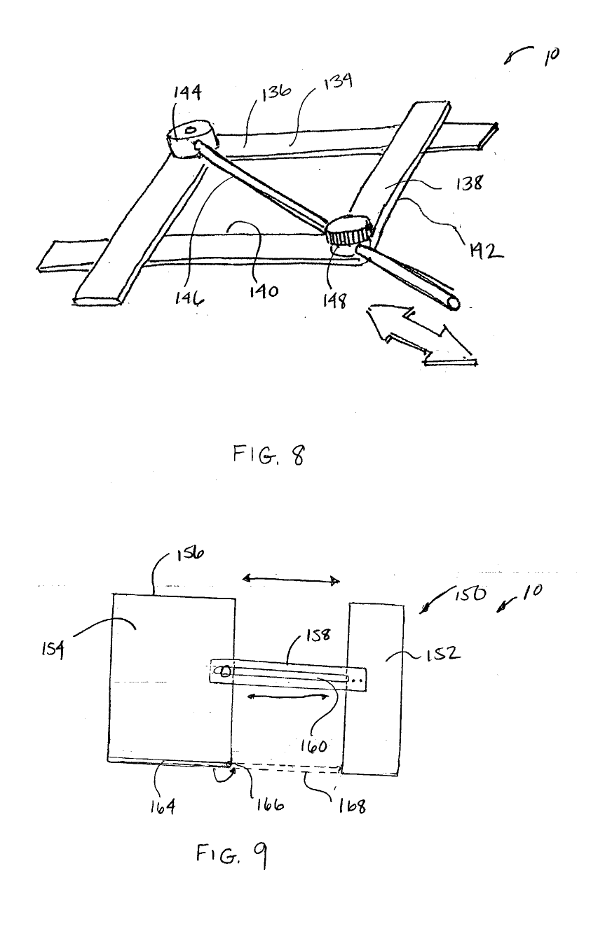

FIGS. 8 and 9 illustrate templates 10 that have an adjustable size and/or shape by moving the template between different positions. Referring to FIG. 8, the body portion 134 includes a first part 136 and a second part 138 that define an inner and an outer boundary edge 140 and 142. The first part includes a spool 144 that pivots with a rod 146 extending from the spool through a knob 148 on the second part. The rod is slidable through the knob and the knob is adjustable to secure the rod in a desired position. The template is thereby adjustable to different sizes and/or shapes by selectively securing the rod in a desired position.

Referring now to FIG. 9, the body portion 150 of the template 10 includes first and second parts 152 and 154 forming a boundary edge 156. A sliding piece 158 is connected to the first part, for example using bolts, and includes a slot 160. A pin 162 is provided through the slot and secured to the second part. The sliding piece may be selectively slid relative to the second part to adjust the size and shape of the body portion of the template by moving the first part relative to the second part. The sliding piece may then be removably secured in the desired position by the pin. It will be appreciated that the body portion may include additional parts that are slidably connected with one another to further adjust the size and/or shape of the template. Further, it will be appreciated that the sliding piece may be slidable relative to both the first and second parts.

Additionally, one or more pivotable tracing pieces 164 may be pivotally connected to the body portion at a pivot 166 such that it may be moved to provide an additional edge to trace when the first and second parts of the template are spaced from one another. The tracing piece 164 may be pivoted such that it has an edge 168 aligned with the boundary edge 156 of the template to make it easier to trace the template with a cutting or writing implement to form the desired sized and shaped insert.

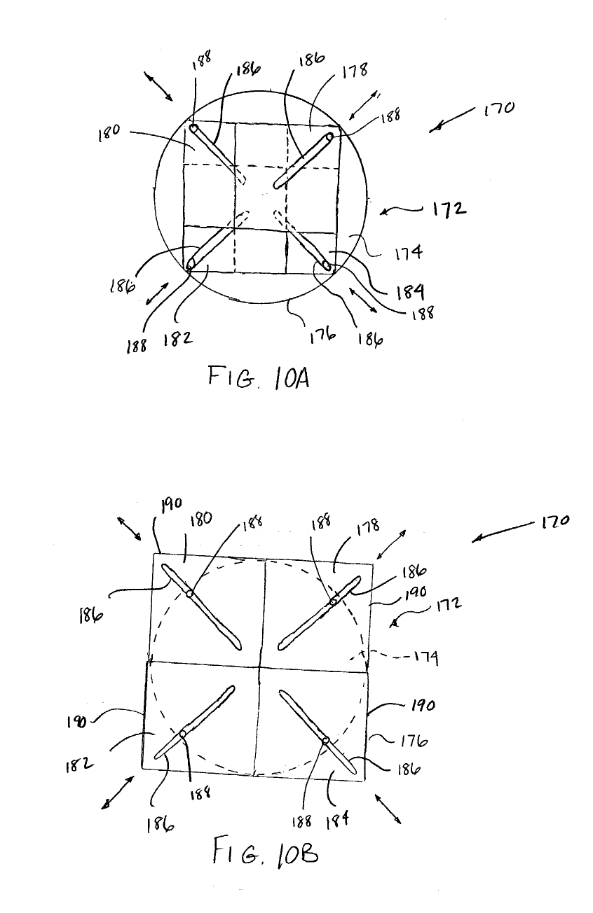

Now referring to FIGS. 10A-10B, a template 170 is shown that is moveable between at least first and second positions to change the shape of the template. Referring to FIG. 10A, the template is provided in a first position. The template includes a body portion 172 with a circular part 174 defining a boundary edge 176 forming a substantially circular shape for making an insert. The body portion 172 additionally includes first, second, third and fourth substantially square parts 178, 180, 182 and 184 slidably connected to the circular part 174 to form the body portion. Each square part includes a slot 186 and is releasably secured to the circular part of the body portion by a pin 188. Each pin may be loosened to allow the square parts to slide to a desired position relative to the circular part to form a boundary edge having a desired shape for the template. The pin may secure the square part in the desired position to prevent further movement.

FIG. 10B illustrates the template of FIG. 10A in a second position. The square parts have all been slid outwardly relative to the circular part such that an edge 190 of each square part now defines the boundary edge 176 of the template which forms a substantially square or rectangular shape. It will be appreciated that the various parts of the body portion may be any suitable shape and may be moveably secured to one another in any suitable manner.

The templates 10, 116 and 170 of FIGS. 1-5 and 7A-10B will now be discussed in more detail. It will be appreciated that the template may be formed of any suitable material, including but not limited to, polycarbonate. The template may be substantially rigid, such that its boundary edges are easier to trace with a writing implement or knife. It may be desirable to have a substantially transparent template, such that the user can see through the template to align the template in the desired position for use. The transparent template may also include a tint. For example, the template may have a grey or any other colored tint such that the template is distinguishable from the material is it to be placed on to form the inserts. It will be appreciated, of course, that the template may be made of an opaque material, and that this material may also be colored.

The boundary edge of the template forming the traceable shape may include an inking edge 126, which allows the edge of the template to be traced by a pen or other writing implement and the resulting shape cut-out without leaving extraneous ink marks on the resulting insert for the media storage case.

Additionally, as shown in FIGS. 1-3, the body portion may feature markers 128 near the boundary edge to identify certain measurements for the user. For example, ribs 130 mark the half-way point along each edge of the body portion. The template may include other measurement markings or indicia for the user either adjacent the outer edges or elsewhere on the body portion of the template. For example, measurement markings 132 as shown in FIG. 1 may be provided similar to those on a ruler, noting either English or metric measurements along the boundary edge. Any suitable measurement points may be marked.

As illustrated in FIGS. 1-7B, the template is formed unitarily such as by injection molding or casting. However, it will be appreciated that the template may be formed of separate pieces suitably secured together.

As discussed above, during use the template may be aligned on a sheet using the gripping portion to place the template over the information about the media. The template boundary edge may then be traced directly with a knife to cut-out the insert or traced with a writing implement. If a writing implement is used, then the insert may be cut-out using scissors or another cutting implement. It will be appreciated that if desired, both sides of the sheet may be printed on such that the resulting insert contains information on both sides of the insert.

If it is desired to form a booklet for the insert, multiple inserts may be provided together in the media storage case and these inserts may be connected together along one edge, such as by stapling, gluing or otherwise binding them together to form a booklet. Alternatively, the template may be used to trace three sides or a substantial portion of the boundary edge, then the template may be slid such that the template may be traced a second time to form two inserts connected along one side to form a double insert. The double insert may be cut-out and folded in the middle to fit within the media storage case to form a booklet. It will be appreciated that more than two inserts may be traced side-by-side from the template. Of course, it will also be appreciated that a rectangular shaped template may be formed that is the size of two inserts side-by-side. The rectangular template may be traced to create a double insert that may be folded and placed within a media storage case and/or used with other inserts to form a booklet.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A template for guiding a writing or cutting implement on a sheet that may be carried relative to a front or back cover, or an edge, of a case adapted to hold media, the template comprising:
a body portion having a boundary edge defining a shape; and
a gripping portion provided on the body portion, the gripping portion constructed and arranged to be gripped by a user to manipulate the position of the template;
wherein the edge defines a shape that corresponds to the shape of an insert for a case adapted to hold media.

2. The template of claim 1, wherein the edge of the template defines an outer boundary of the body portion.

3. The template of claim 1, wherein the edge of the template defines an inner boundary of the body portion.

4. The template of claim 1 further comprising at least one recess adapted to define the gripping portion.

5. The template of claim 1, wherein the gripping portion includes a handle adapted to be gripped by a user.

6. The template of claim 1, wherein the shape is substantially square.

7. The template of claim 1, wherein the shape of the template is substantially circular.

8. The template of claim 1, wherein the template is substantially the same size and shape as an insert for a case adapted to hold media.

9. The template of claim 1, wherein the shape of the template is adjustable between a first shape and a second shape.

10. The template of claim 1, wherein the boundary edge defines a size and the boundary edge is adjustable between first and second positions to adjust the size.

11. The template of claim 1, wherein at least a portion of the template is transparent.

12. The template of claim 1, wherein the template includes polycarbonate.

13. The template of claim 1, wherein at least a portion of the template is substantially rigid.

14. The template of claim 1, wherein the template is substantially solid.

15. A method for forming an insert for case adapted to hold media, comprising the steps of:
providing a template including a body portion having an edge defining a shape, wherein the edge defines a shape that corresponds the shape of an insert for a case adapted to hold media;
positioning the template on a sheet; and
tracing the edge with an implement.

16. The method of claim 15, wherein the implement includes a cutting implement.

17. The method of claim 15, wherein the implement includes a writing implement.

18. The method of claim 17, further comprising the step of cutting-out the shape traced on the sheet to form an insert.

19. The method of claim 18, further comprising the step of placing the insert in a case adapted to hold media.

20. The method of claim 15, further comprising the step of adjusting the body portion between a first position and a second position.

21. The method of claim 15, further comprising the step of:
gripping a gripping portion provided on the body portion, the gripping portion constructed and arranged to be gripped by a user to position the template on the sheet.

22. The method of claim 21, wherein the gripping portion includes at least one recess adapted to define the gripping portion.

23. The method of claim 21, wherein the gripping portion includes a handle adapted to be gripped by a user.
